(19) United States
(12) Patent Application Publication
(10) Pub. No.: US 2002/0029930 A1
(43) Pub. Date: Mar. 14, 2002

(54) Low level scaffold with ballscrew drive

(76) Inventor: Frederick N. Bassett JR., Salisbury, MA (US)

Correspondence Address: FREDERICK N. BASSETT, JR., 43 SEABROOK ROAD, SALISBURY, MA, 01952, US

(21) Appl. No.: 09/905,731

(22) Filed: Jul. 14, 2001

Related U.S. Application Data
(60) Provisional application No. 60/221,945, filed on Jul. 31, 2000.

(51) Int. Cl. B66F 7/06

(52) U.S. Cl. 182/69.5; 187/211

(57) ABSTRACT

A low level scaffold with ball screw drive is a lightweight, mobile, compact, electrically activated, self-erecting, scissor-type lifting platform. The electronic system utilizes an electric motor in direct drive arrangement with a ball screw assembly to vary the platform height from a retracted position to extended position. Electric switches limit reverse direction between the retracted and extended positions to vary platform height anywhere between the minimum and maximum heights above ground level. The design allows for transportation through household doorways and provides anti-tilt arms with threaded level mounts for use on non-level surfaces. The scaffold provides homeowners and small commercial contractors with an apparatus to perform small interior and exterior projects at elevated heights.

### CROSS REFERENCE TO RELATED APPLICATIONS

This application claims priority of Provisional Application No. 60/221,945, entitled LOW LEVEL SCAFFOLD filed on Jul. 31, 2000, and which is incorporated herein by reference.

### BACKGROUND OF THE INVENTION

This invention relates to a scaffold having an electric drive for lifting a user, equipment, and materials from a ground level to an elevated working level within a contained area of height and width and to stabilize the scaffold on non-level ground, and mobility through interior passageways.

The homeowner and small commercial contractor struggle with small interior and exterior projects that are at elevated heights. They primarily rely are stepladders, stools, and extension ladders for these projects. The user must constantly travel up and down these structures to retrieve tools and materials. The work area is limited to the reach to the user. This places the user in an unsafe situation that may result in a fall from an elevated height. As the user leans to extend his reach, the ladder or stool may become unstable and tilt or the user may loose his grip or balance and fall to the ground. Also, the user needs to constantly reposition the structure as the work progress. This is very inefficient wasting precise time. Stability of the structure is also an issue when working on unleveled surfaces. This is a particular problem when outdoors.

Conventional aerial lifts are primarily designed for commercial and industrial users. The lifts initial purchase costs are high with significant reoccurring maintenance costs. The lifts employ hydraulics to elevate working platforms. The hydraulics requires significant maintenance and are constantly leaking making these machines unsuited for internal use for home or light industrial or small commercial operations. The relative size of the available machines also limits their use to external areas or internal spaces with wide doorways and high ceiling. Their use within a home or office is prohibited due to maneuverability through passageways and the leaking hydraulic fluid. Most conventional aerial lifts are powered by diesel engines, propane motors or large battery packs that also limits their usage within structures due to environment issues.

In order to work safety at elevated heights within a house or office for the purpose of installing or fixing electric fixtures, painting walls or ceiling, or changing light bulbs, it is necessary to have an apparatus that is lightweight, low cost, portable and mobile, anti-tilt, sufficient load lifting capabilities, compact design in full retracted position, transportable through doorways, platform work area sufficient to reduce up and down trips by operator, level mount features allow placement on non-level surfaces, and a motorized direct drive elevating means to eliminate the hydraulics.

Accordingly, several objects and advantages of my invention are to provide the consumer with a low cost, portable, mobile, multi-purpose scaffold for household use and light duty construction and maintenance.

It is a further object of this invention to provide a scaffold that is of lightweight construction with anti-tilt features.

It is a further object of this invention to provide a scaffold that has load-lifting capabilities up to 600 pounds.

It is another object of this invention to provide a scaffold that is compact in full-retracted position.

It is another object of this invention to provide a scaffold that is transportable through building doorways.

It is yet another object of this invention to provide a scaffold with a platform work area that limits up and down trips by operator.

It is a further object of this invention to a scaffold with level mount features that allow a scaffold to be placed on non-planar surfaces.

It is a further object of this invention to provide a scaffold with a motor direct drive system that eliminates oil leakages associated with hydraulic systems.

Still further objects and advantages will become apparent from a consideration of the ensuing description and accompanying drawings.

### SUMMARY OF THE INVENTION

The objects set forth above as well as further and other objects and advantages of the present invention are achieved by the embodiments of the invention described hereinbelow.

Briefly stated, the preferred embodiment introduces an improvement in scissor advancement mechanism that enables significant reduction in the size of a lifting scaffold for multipurpose use. The present invention provides a means for lifting construction material, tools and workman to working heights within a confined working area. For example, one embodiment of the present invention provides a lifting platform of conventional design wherein the platform is lifted from ground level and maintained in a substantially level height by a known scissor arrangement. The invention is sized to allow transportation through household doorways and other limiting structures. The scissor arrangement raises a load by mechanical lifting means driven by at least on electric motor means powered by AC or DC power. Preferably the mechanical lifting means includes at least one ball screw. The ball screw is connected to the scissor arrangement such that as the electric motor rotates the screw, the scissors open and the platform raises. The present invention employs the advantages of using a mechanical drive rather than hydraulic fluid to elevate the platform.

An alternative embodiment includes electric micro switches provided in the assembly design to limit the extension and retraction position of the upper movable platform anywhere within a desired height range, preferably between 1 and 6.5 feet above surface level. These micro switches shut down electric power to the drive motor when mechanically activated.

Another alternative embodiment includes casters for maneuverability and allows the operator to transport the apparatus from location to location in similar manner to a dolly.

Yet another alternative embodiment includes stabilizing arms located on the stationary base to preclude the assembly from tipping over when the upper movable platform is fully extended. Leveling mounts located on the stabilizing arms allow the assembly to be mounted on non-level surfaces.

For a better understanding of the present invention, together with other and further objects thereof, reference is made to the accompanying drawings and detailed description and its scope will be pointed out in the appended claims.

### BRIEF DESCRIPTION OF THE DRAWINGS

FIG. 1 is pictorial of the preferred embodiment;

FIG. 2 is a side view of the scissor advancement mechanism attached to the stationary base and coupled to a scissor arm;

FIG. 3a is a side view of the preferred embodiment in a fully extended position;

FIG. 3b is a side view of the preferred embodiment in a fully retracted position;

FIG. 4 is a schematic of the electrical circuitry;

FIG. 5 is a cross-section of the ball screw mechanism;

FIG. 6a is a top view of the scissor advancement mechanism in the fully extended position;

FIG. 6b is a top view of the scissor advancement mechanism in the fully retracted position;

FIG. 7 is a pictorial view of a lower rail;

FIG. 8 is a front view of the dovetail rail configuration;

FIG. 9 is a pictorial view of a stabilizing arm; and

FIG. 10 is a pictorial view of a level mount.

### DETAILED DESCRIPTION OF THE PREFERRED EMBODIMENTS

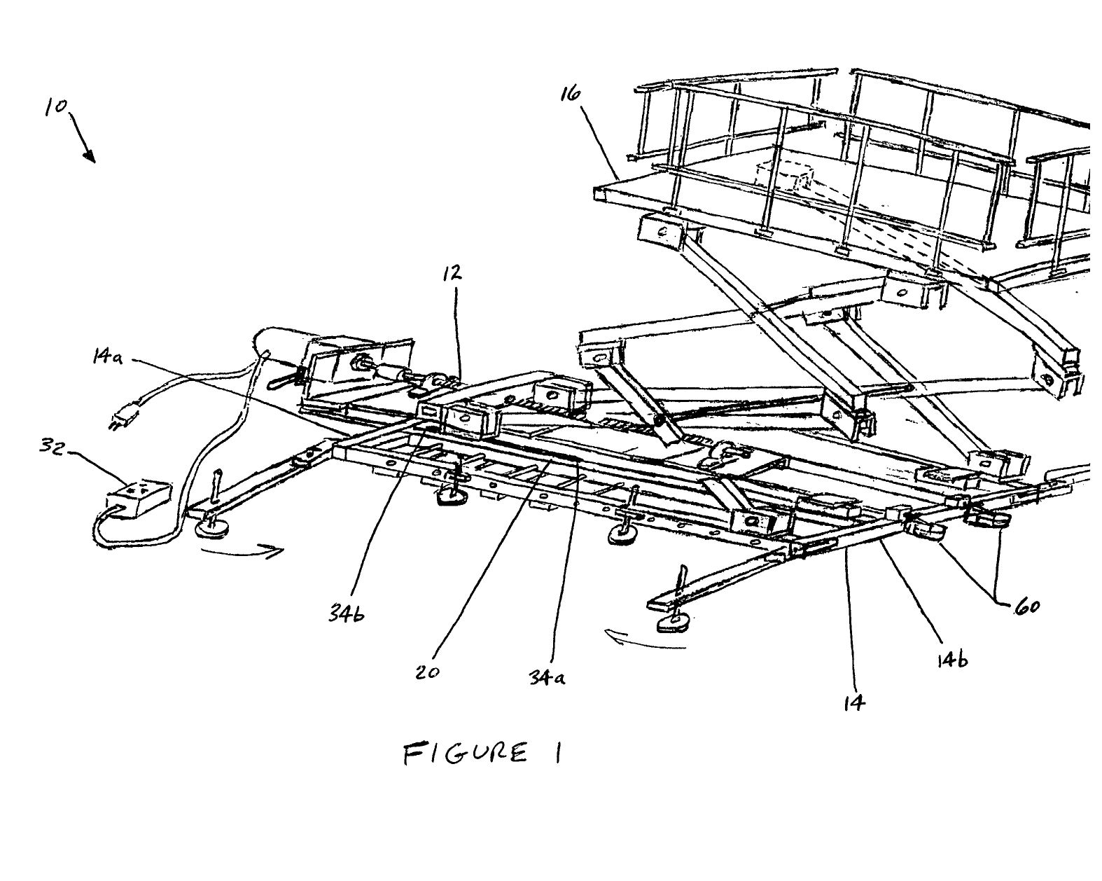

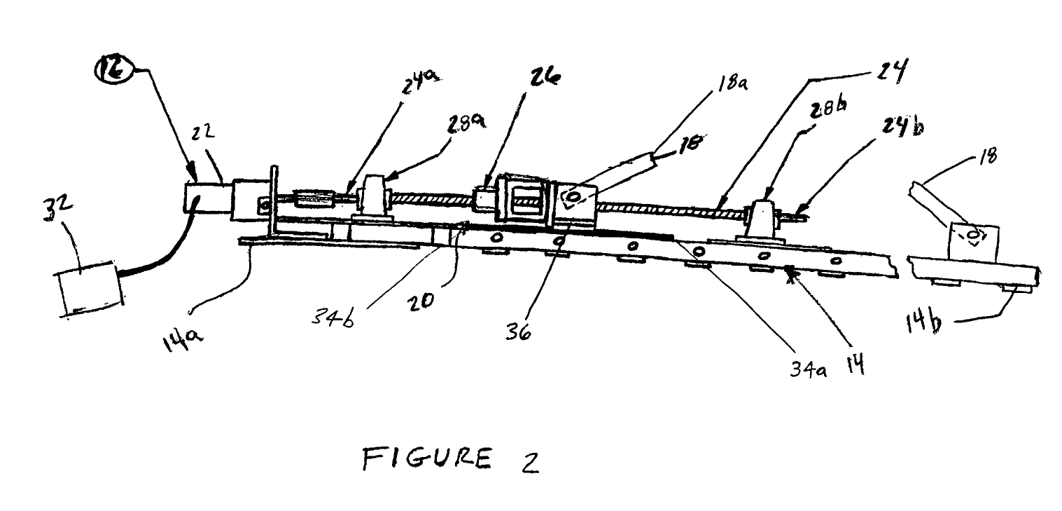

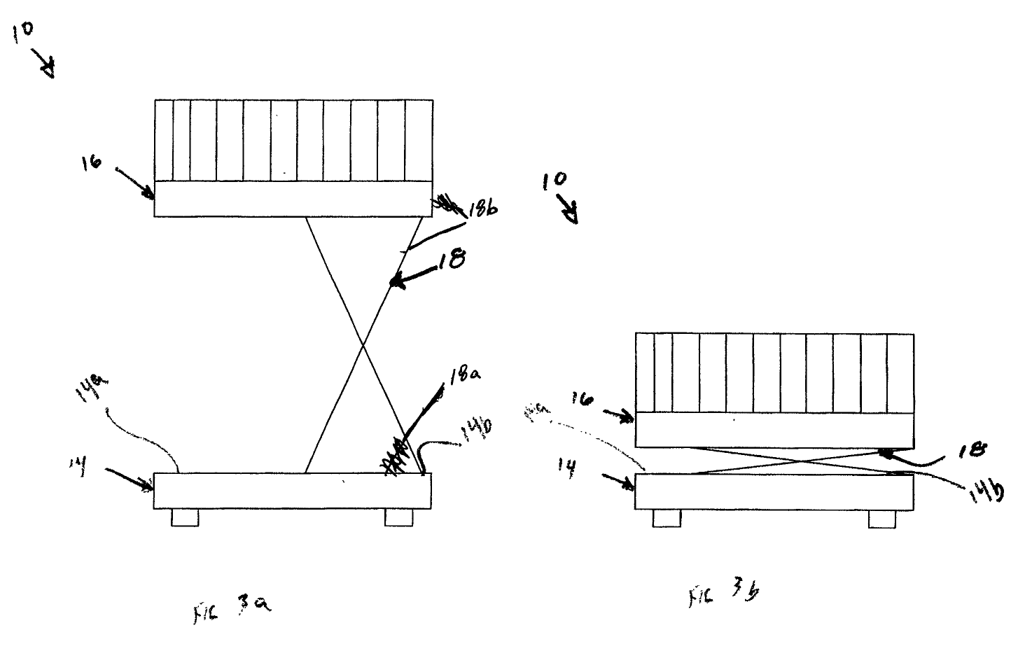

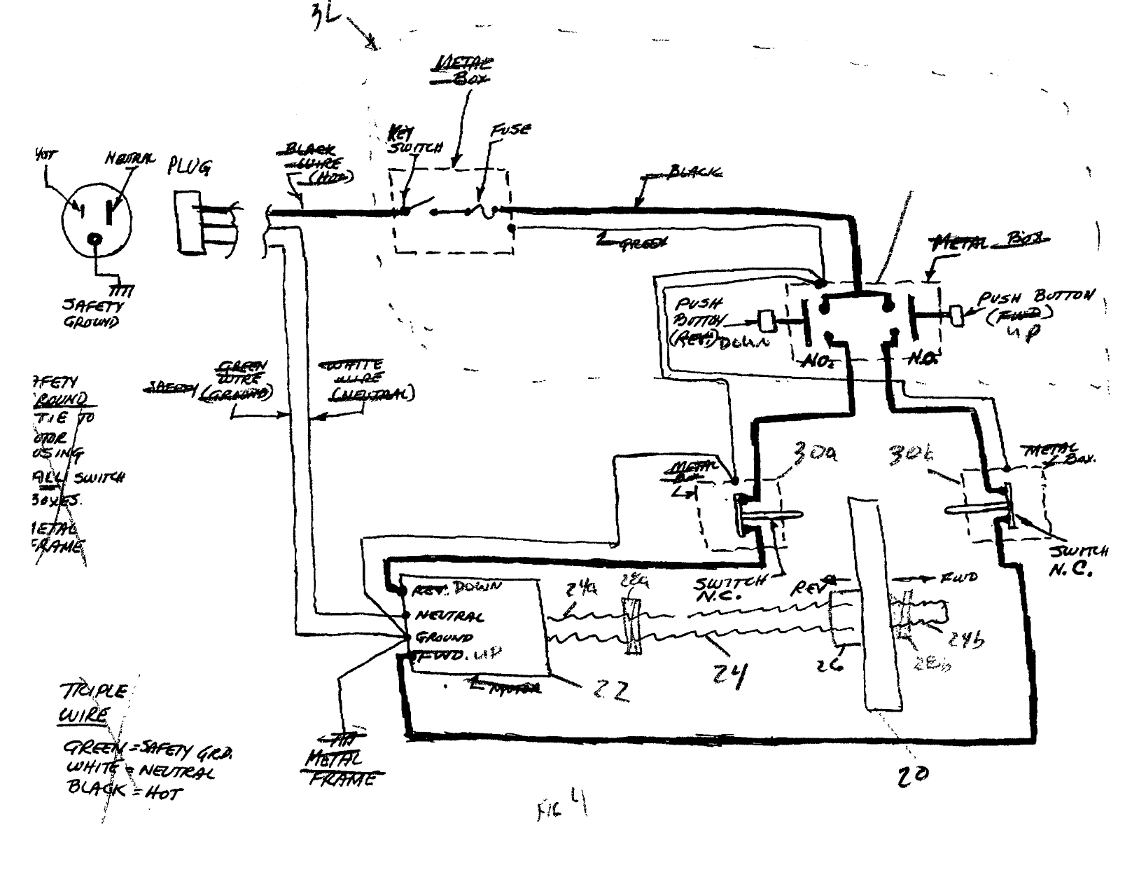

The preferred embodiment 10 (FIG. 1) includes an improved scissor advancement mechanism 12 (FIG. 2) that enables significant reduction in the size of a lifting scaffold for multipurpose use. Though the basic design of the stationary base 14, the upper movable platform 16, and the scissor assemblies 18 are standard and known to the art (also illustrated in FIGS. 3a and 3b), as discussed in detail in Provisional Application No. 60/221,945, entitled LOW LEVEL SCAFFOLD, the combination of the compact size and the improved scissor advancement mechanism 12 advances the art of lifting platforms. Each of the novel features will be discussed in detail below. Though a compact-sized lifting scaffold is illustrated, any size lifting scaffold is within the contemplation of the invention.

As illustrated in FIGS. 1, 2, 3a, and 3b, the preferred embodiment 10 is comprised of a scissor advancement mechanism 12, a stationary base 14, an upper movable platform 16 disposed above the stationary base 14, scissors lifting assemblies 18 having a lower 18a and upper portion 18b being interconnected between the stationary base 14 and the upper movable platform 16, and a rail system 20. The rail system 20 is fixedly connected to the scissor advancement mechanism 12, in slidable contact with the stationary base 14 and upper movable platform 16, and pivotally coupled to the scissors lifting assemblies 18. The rail system (not shown) for the upper movable platform 16 is the same as for the stationary base 14, and therefore the discussion of the rail system 20 adapted to the stationary base 14 is applicable to a rail system adapted to the upper movable platform 16.

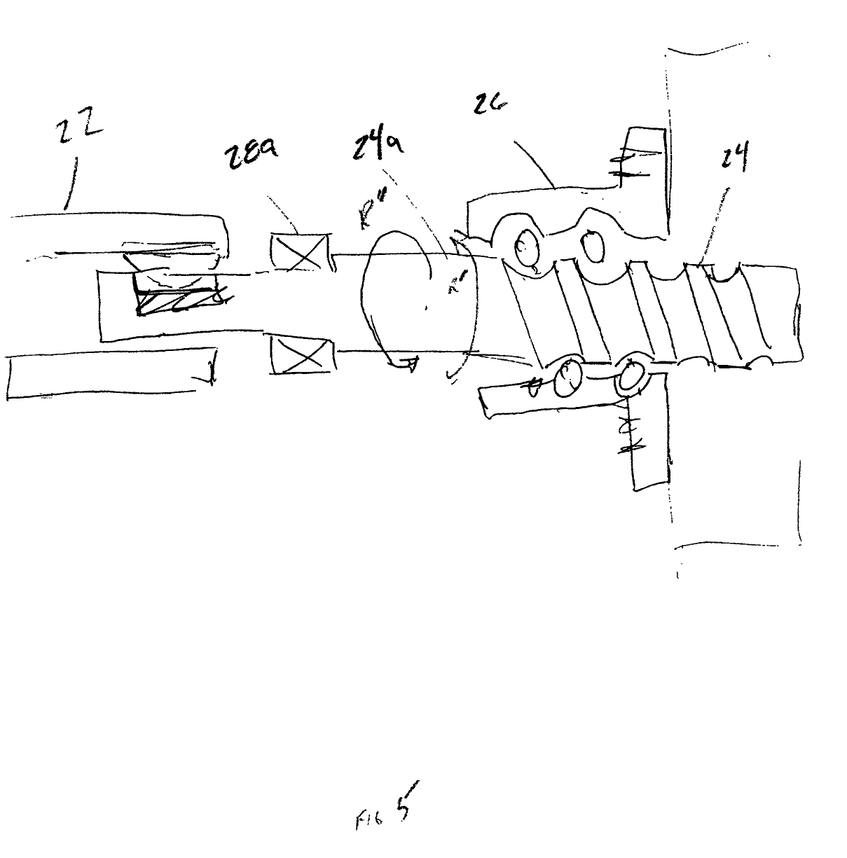

The scissor advancement mechanism 12 is a combination of mechanical and electrical components, as illustrated in FIGS. 2 and 4. The scissor advancement mechanism 12 comprises a drive motor 22, an externally threaded ball screw shaft 24 having a first 24a and a second 24b ends, an internally threaded nut 26, two bearings 28a, 28b, electric micro switches 30a, 30b (FIG. 4 only), and a hand control 32. The scissor advancement mechanism 12 (as shown in FIG. 2.) is fixedly mounted to the stationary base 14 with the drive motor 22 being mounted at the first end 14a, which opposes the scissors lifting assemblies 18 fixed pivotable attachment point at the second end 14b.

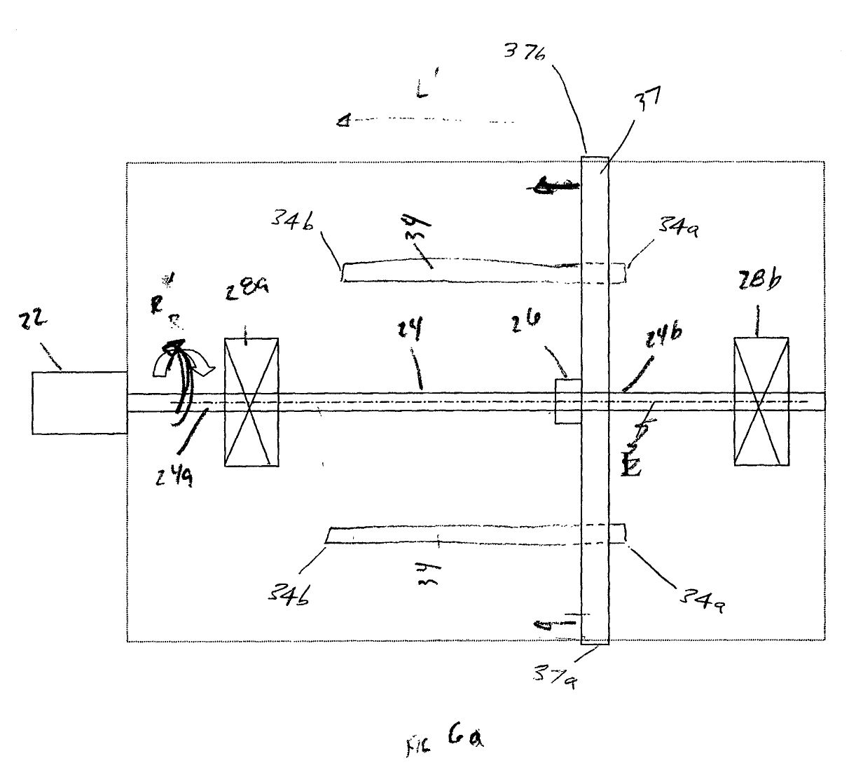

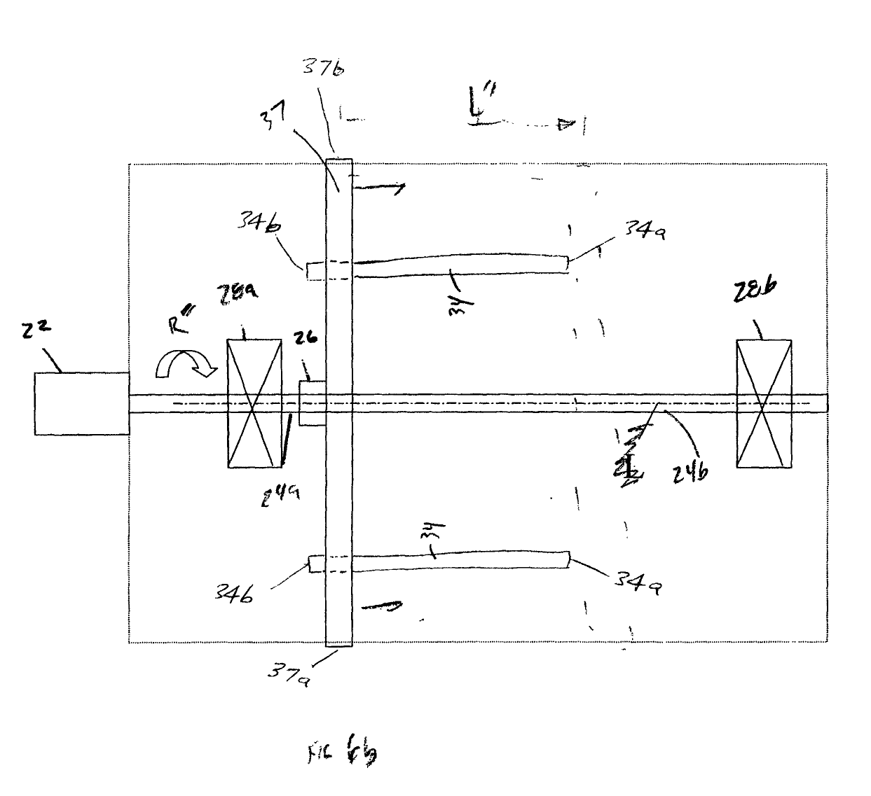

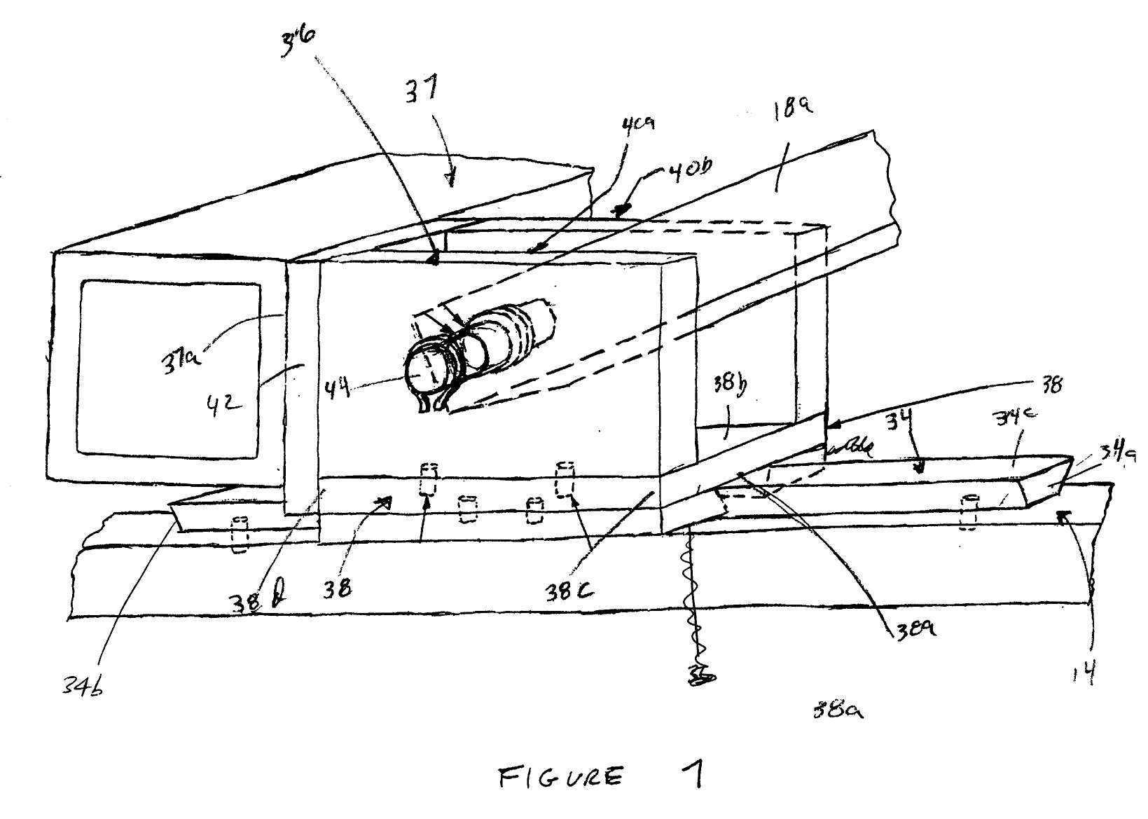

As illustrated in FIGS. 5, 6a, and 6b, the internally threaded nut 26 is threadably rotatable on the ballscrew shaft 24, and is responsive to rotation of the ballscrew shaft 24 in the opposite first R′ and second R″ angular directions. The internally threaded nut 26 is movable in the opposite first L′ and second L″ linear directions between a retracted position, wherein the internally threaded nut 26 is located adjacent to the first end 24a of the ballscrew shaft 24, and an extended position, wherein the internally threaded nut 26 is located adjacent to the second end 24b of the ballscrew shaft 24.

The wiring schematic shown in FIG. 4 illustrates the elevation control of the upper movable platform 16. Electric micro switches 30a, 30b are provided on the stationary base 14 and upper movable platform 16 at predetermined locations to limit the extension and retraction position of the upper movable platform 16 anywhere within a desirable height range, preferably between 1 and 6.5 feet above surface level. These micro switches 30a, 30b shut down electric power to the drive motor 22 when mechanically activated. Electronic switch 30a shuts down power when the upper movable platform 16 descends below a predetermined point. Electronic switch 30b shuts down power when the upper movable platform 16 ascends above a predetermined point. A hand control 32 electrically connected to the drive motor 22 allows the operator to vary the height of the upper movable platform 16. The drive motor 22 of this assembly is single-phase operating from 115 volts, 60-hertz or 230 volts, 50-hertz household AC electric power or DC electric power.

The rail system 20 connects the major components of the preferred embodiment 10. As mentioned above, the rail system 20 is fixedly connected to the scissor advancement mechanism 12, in slidable contact with the stationary base 14 and upper movable platform 16, and pivotally coupled to the scissors assemblies 18. As illustrated in FIG. 1, the rail system 20 includes two rails 34, two rail guides 36,and a drive tube 37. There are two rails 34 and two guide rails 36 for each the stationary base 14 and the upper movable platform 16. The disclosure will be in terms of a rail system mounted on the stationary base 14, however the structure for a rail system mounted to the upper movable platform 16 is exactly the same regarding the rails, the rail guides, and pivotal coupling with the scissor assemblies 18.

As illustrated in FIGS. 1, 6a, 6b, 7 and 8, the rail 34 includes an opposite first 34a and second 34b ends, and a top surface 34c, and is mounted longitudinal on the stationary base 14 between the stationary base ends 14a and 14b. The positioning of the rail and number of rails are dependent on the load limits of the invention. The top surface 34c was made of or coated with low friction material for easy rail guide 36 sliding.

The drive tube 37 is used to connect multiple rail guides 36 to the same drive motor 22. As illustrated in FIGS. 6a and 6b, the preferred embodiment 10 uses one drive motor 22 working in cooperation with one ballscrew shaft 24, one internally threaded nut 26, and two rails 34. Therefore, a coupling between the two rails 34 is required to translate both rail guides 36 along the rails 34 simultaneously. In cases where only one rail 34 is used, then there is no need for the drive tube 37.

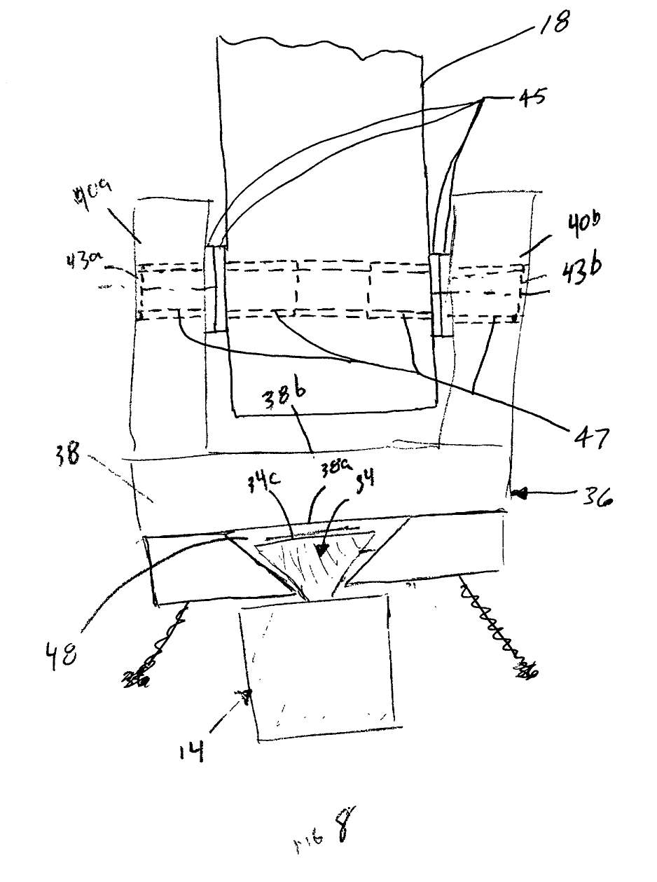

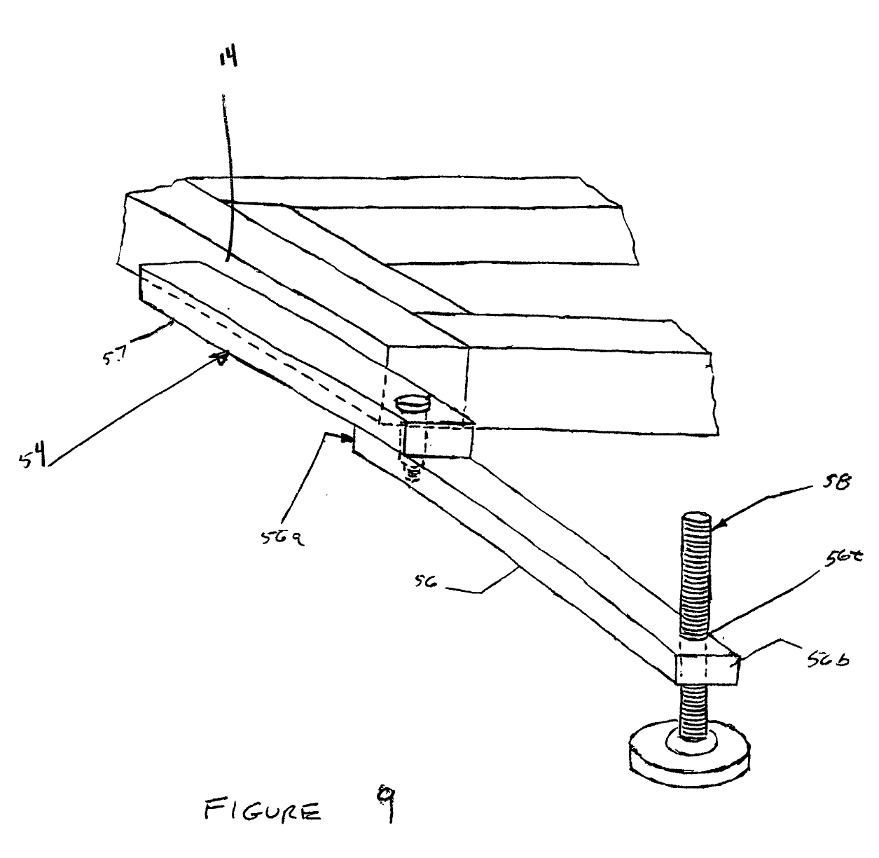

As illustrated in FIGS. 7 and 8, the rail guide 36 includes a base plate 38, a pair of pivot plates 40a, 40b, and a coupling plate 42. The base plate 38 includes a lower surface 38a, a top surface 38b, and opposite first end 38c and second end 38d. The second end 38d being attached at a first end 37a of the drive tube 37. As illustrated in FIGS. 6a and 6b, the drive tube 37 is fixedly attached to the internally threaded nut 26 at a predetermined location such that when the internally threaded nut 26 undergoes movement in the opposite first L′ and second L″ linear directions the drive tube 37 applies equal force upon the rail guides 36, whereby the rail guides 36 move along the rails 34 at the same velocity and distance.

As illustrated in FIGS. 7 and 8, the rail guide 36 includes pivot holes 43a, 43b sufficiently sized to mount a plurality of low friction material flanged sleeve bearings 45. The scissor lift lower portion 18a also includes a pivot hole 46 (not shown) sufficiently sized to mount a plurality of low friction material flanged sleeve bearings 45. All flanged sleeve bearings 45 include a sleeve pivot hole 47 sufficiently sized such that a round shaft 44 freely rotates. Thereby, the guide rail 36 and the lower portions 18a of the scissor lift assembly are rotatably coupled by the round shaft 40 to operate the scissor lifting assembly 18 between the retracted (FIG. 3b) and expanded (FIG. 3a) conditions as the ballscrew shaft 24 is rotated in the opposite first R′ and second R″ angular directions.

The rail guide base lower surface 38a is in slidable contact with the top surface 34c of the rail 34 as the rail guide 36 translates in the opposite first L′ and second L″ linear directions. The base plate 38 of the rail guide 36 further includes a channel 48 through the lower surface 38a. The channel 48 of the rail guide 36 and the rail 34 are a dovetail configuration (FIG. 8), both sufficiently sized such that the channel 48 of the rail guide 36 freely slides along the rail 34, and to contain the rail guide 36 from extending upwardly under loading conditions as the rail guide 36 translates in the opposite first L′ and second L″ linear directions.

The rail system 49 (partial shown in FIG. 1) of the upper movable platform 16 is identical to the rail system 20 described above. The rail guide 50 of the upper movable platform 16 translates along the rail (not shown) attached to the upper movable platform 16 as the upper portion 18b of the scissor assemblies 18 applies a force to the rail guides 50 similar to the force applied by the drive tube 37 upon the rail guides 36 on the stationary base 14.

### MODE OF OPERATION

The operator of the present invention positions the invention in a work area, loads the material and tools on to the upper movable platform 16, steps on to the upper movable platform 16, and turns on the motor. The operator pushes the up button to engage the drive motor 22 with the ballscrew shaft 24. The ballscrew shaft 24 undergoes rotation R′ in a first angular direction. The internally threaded nut 26 undergoes translation L′ in a first linear direction so as to cause movement of the scissors assemblies 18 vertically toward the extended condition and thereby movement of the upper movable platform toward the raised position (FIG. 3a). When the operator reaches the desired height, the operator releases the up button to disengage the ballscrew shaft 24 from the drive motor 22.

Upon completion of the work, the operator pushes the down button and the upper movable platform 16 descends. The ballscrew shaft 24 undergoes rotation R″ in a second angular direction opposite to the first angular direction, and the internally threaded nut 26 undergoes translation L″ in a second linear direction opposite to the first linear direction so as to cause movement of the scissor assemblies 18 vertically toward the retracted condition and thereby movement of the upper movable platform 16 toward the lowered position (FIG. 3b). Once the upper movable platform 16 lowers to the desire ascent height, the operator releases the down button.

Preferably, the scissor advancement mechanism 12 also includes electronic switches 30a, 30b (as mentioned above), which effectively stop the upper movable platform 16 at maximum ascent and descent heights.

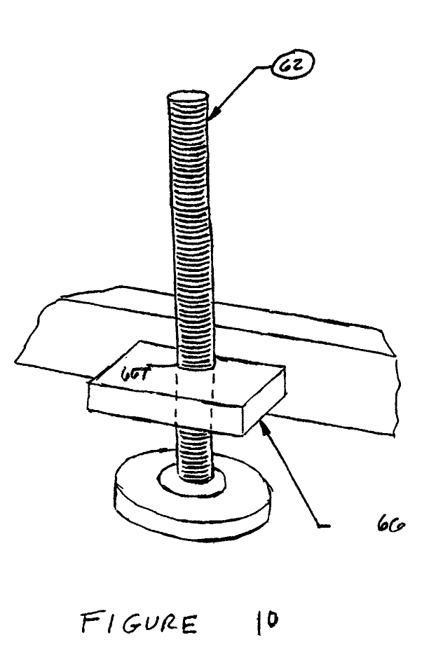

An alternative embodiment, illustrated in FIG. 1, includes stabilizing arms 54 connected to predetermined locations of the stationary base 14. As illustrated in FIG. 9, the stabilizing arm 54 includes a pivot arm 56, having opposite first 56a and second 56b ends, and a mounting arm 57. The mounting arm 57 being fixedly attached to the stationary base 14. The pivot arm first end 56a is pivotally coupled to the mounting arm 57 for retraction when the apparatus is not in use and extension when the apparatus is in use. The second end 56b includes a threaded hole 56t to receive an externally threaded swivel level mount 58, whereby the stabilizing arms 54 are variably extendible for use in confined areas or for adjusting for loads that affect the center of gravity of the apparatus. The externally threaded swivel level mount 58 is threadably rotatable into the threaded hole 56t of the pivot arm 56, whereby the swivel level mount 58 is threaded into the threaded hole 56T of the pivot arm 56 to a height sufficient to adapt the apparatus for use on non-level surfaces providing a stable surface for the apparatus to operate.

In another alternative embodiment, the stationary base 14 further includes at least one caster 60 (FIG. 1), whereby the caster adapts the apparatus for easy movement, transportation, repositioning, or realignment by one individual.

In yet another alternative embodiment, the stationary base 14 further includes a plurality of externally threaded swivel level mounts 62 (FIG. 10) being connected to predetermined locations of the stationary base 14. The threaded swivel level mount 62 is threadably rotatable into the threaded hole 66t of a mount plate 66, whereby the swivel level mount 62 is threaded into the threaded hole 66T of the mount plate 66 to a height sufficient to adapt the apparatus for use on non-level surfaces providing a stable surface for the apparatus to operate. The mount plate 66 is fixedly attached to the stationary base 14.

Although the invention has been described with respect to various embodiments, it should be realized this invention is also capable of a wide variety of further and other embodiments within the spirit and scope of the appended claims.

What is claimed is:

1. A low level scaffold, comprising:
(a) a stationary base, the stationary base having a first end and a second end;
(b) an upper movable platform disposed above the stationary base;
(c) a plurality of scissors lifting assemblies 18 being interconnected between the stationary base and the upper movable platform, the scissors lifting assemblies 18 having a lower and an upper portion; and
(d) an scissor advancement means being fixedly mounted to the stationary base between the first and second ends of the stationary base and being pivotally coupled to at least one scissor lifting assembly and adapted to operate the scissor lifting assembly between the retracted and expanded conditions, the scissor advancement system being operable to undergo rotation in a first angular direction and translation in a first linear direction so as to cause movement of the scissor lifting assemblies vertically toward the retracted condition and thereby movement of the upper movable platform toward the lowered position and to undergo rotation in a second angular direction opposite to the first angular direction and translation in a second linear direction opposite to the first linear direction so as to cause movement of the scissor lifting assembly vertically toward the expanded condition and thereby movement of the upper movable platform toward the raised position.

2. The apparatus as recited in claim 1, wherein the scissor advancement means includes:
(a) a motor;
(b) an externally threaded ballscrew shaft having opposite first and second ends, the first end being rotatably connected to the motor, and being rotatable in the opposite first and second angular directions in response to the motor actuation; and
(c) an internally threaded nut threadably rotatably attached to the ballscrew shaft and in response to rotation of the ballscrew shaft in the opposite first and second angular directions being movable in the opposite first and second linear directions between a retracted position wherein the nut is located adjacent to the first end of the ballscrew shaft and an extended position wherein the nut is located adjacent to the second end of the ballscrew shaft.

3. The apparatus as recited in claim 2, wherein the scissor advancement means further includes at least one support bearing rotatably coupled to and supporting the first ends or the second end of the ballscrew shaft.

4. The apparatus as recited in claim 2, wherein the scissor advancement means further includes at least one limiting switch to cut power to the motor when maximum or minimum heights are obtained, whereby the scissor assemblies are stopped before exceeding predetermined extending and retracting positions.

5. The apparatus as recited in claim 1, wherein the apparatus further includes:
(a) at least one rail having opposite first and second ends, and a top surface; and
(b) at least one rail guide having a mount plate with a lower surface and opposite first and second ends being attached at the first end to the nut for undergoing movement therewith in the opposite first and second linear directions, the rail guide base lower surface in slidable contact with the top surface of the rail as the rail guide translates in the opposite first and second linear directions, the rail guide being pivotally connected to the lower and upper portion of at least one scissor assembly.

6. The apparatus as recited in claim 1, wherein the apparatus further includes:
(a) a plurality of rails, each rail having opposite first and second ends, and a top surface;
(b) a plurality of rail guides, each rail guide having a mount plate with a lower surface and opposite first and second ends, the rail guide base lower surface in slidable contact with the top surface of the rail as the rail guide translates in the opposite first and second linear directions, the rail guide being pivotally connected to the lower and upper portion of at least one scissor assembly; and
(c) a drive tube having a first and a second surface, the first surface being attached to the first end of the plurality of rail guides, the second surface being attached to the nut for undergoing movement therewith in the opposite first and second linear directions.

7. The apparatus as recited in claim 1, wherein the lower and the upper portions of the scissors lifting assemblies 18 include a plurality of pivot holes.

8. The apparatus as recited in claim 7, wherein the rail guide includes:
(a) a round shaft, the round shaft sufficiently sized to freely rotate within the pivot holes of the scissor lift assemblies; and
(b) a mobile pivot assemble having a pair of pivot plates, with a plurality of pivot holes sufficiently sized to receive the round shaft, mounted to and extending upwardly from and on opposite sides of the mount plate for rotatable connection with the lower portions of the scissor lifting assembly interposed between the pivot plates, the mobile pivot assembly and the lower portions of the scissor lift assembly rotatably coupled by the round shaft.

9. The apparatus as recited in claim 8, wherein the mount plate of the lower rail guide further includes a channel along the lower surface sufficiently sized to contain the lower rail from extending upwardly under loading conditions as the lower rail guide translates in the opposite first and second linear directions.

10. The apparatus as recited in claim 9, wherein:
(a) the channel of the lower rail guide is a dovetail configuration; and
(b) the lower rail is a dovetail configuration, the lower rail dovetail configuration being sufficiently sized to freely slide within the channel of the lower rail guide.

11. The apparatus as recited in claim 1, wherein the stationary base further includes a plurality of externally threaded swivel level mounts, the swivel level mount being adaptable to non-level surfaces, whereby a stable surface is create for the apparatus to operate safely.

12. The apparatus as recited in claim 1, wherein the stationary base further includes a plurality of stabilizing arms.

13. The apparatus as recited in claim 12, wherein the stabilizing arms include:
(a) a pivot arm having opposite first and second ends, the first end being pivotally coupled to the stationary base for retraction when the apparatus is not in use and extension when the apparatus is in use, the second end having a threaded hole, whereby the stabilizing arms are variably extendible for use in confined areas or for adjusting for loads that affect the center of gravity of the apparatus; and
(b) an externally threaded swivel level mount threadably rotatable into the threaded hole of the pivot arm, the swivel level mount threaded into the threaded hole of the pivot arm to a height sufficient to adapt the apparatus for use on non-level surfaces, whereby providing a stable surface for the apparatus to operate.

14. The apparatus as recited in claim 1, wherein the stationary base further includes at least one caster, whereby the caster adapts the apparatus for easy movement, transportation, repositioning, or realignment by one individual.

15. The apparatus as recited in claim 1, wherein the motor is an electric motor.

16. The apparatus as recited in claim 7, wherein the upper movable platform includes:
(a) at least one upper rail having opposite first and second ends, and having opposite first and second side surfaces; and
(b) at least one upper rail guide having a mount plate with opposite first and second side surfaces and opposite first and second ends, the upper rail guide opposite first and second side surfaces in slidable contact with the opposite first and second side surfaces of the upper rail as the upper rail guide translates in the opposite first and second linear directions, the upper rail guide being pivotally connected to the upper portion of at least one scissor lift assembly.

17. The apparatus as recited in claim 16, wherein the upper rail guide includes:
(a) a round shaft, the round shaft sufficiently sized to freely rotate within the pivot holes of the scissor lift assemblies; and
(b) a mobile pivot assembly having a pair of pivot plates, with a plurality of pivot holes sufficiently sized to receive the round shaft, mounted to and extending downwardly from and on opposite sides of the mount plate for rotatable connection with the upper portions of the scissor lifting assembly interposed between the pivot plates, the mobile pivot assembly and the upper portions of the scissor lift assembly rotatably coupled by the round shaft.

18. The apparatus as recited in claim 17, wherein the mount plate of the upper rail guide further includes a channel along the upper surface sufficiently sized to contain the upper rail from extending downwardly under loading conditions as the upper rail guide translates in the opposite first and second linear directions.

19. The apparatus as recited in claim 18, wherein:
(a) the channel of the upper rail guide is a dovetail configuration; and
(b) the upper rail is a dovetail configuration, the upper rail dovetail configuration being sufficiently sized to freely slide within the channel of the upper rail guide.

20. An scissor advancement system, comprising:
(a) an externally threaded ballscrew shaft having opposite first and second ends and being rotatable in the opposite first and second angular directions;
(b) an internally threaded nut threadably rotatably coupled to the ballscrew shaft and in response to rotation of the ballscrew shaft in the opposite first and second angular directions being movable in the opposite first and second linear directions between a retracted position wherein the nut is located adjacent to the first end of the ballscrew shaft and an extended position wherein the nut is located adjacent to the second end of the ballscrew shaft;
(c) at least one lower rail having opposite first and second ends, and a top surface;
(d) at least one lower rail guide having a mount plate with a lower surface and opposite first and second ends being attached at the first end to the nut for undergoing movement therewith in the opposite first and second linear directions, the lower rail guide base lower surface in slidable contact with the top surface of the lower rail as the lower rail guide translates in the opposite first and second linear directions, the lower rail guide being pivotally connected to the lower portion of at least one scissor lift assembly;
(e) a plurality of support bearing elements rotatably coupled to and supporting the first and second ends of the ballscrew shaft; and
(f) an electric motor drivingly coupled to the first end of the ballscrew shaft.

21. A low level scaffold, comprising:
(a) a stationary base;
(b) an upper movable platform disposed above the stationary base;
(c) a plurality of scissors lifting assemblies 18 being interconnected between the stationary base and the upper movable platform, the scissors lifting assemblies 18 having a lower and an upper portion;
(d) mechanical lifting means for varying the height of the upper movable platform with respect to the stationary base;
(e) electrical motor drive means connected to the mechanical lifting means for raising the upper movable platform; and
(f) electrical energy means for powering the electric motor drive means.

22. The apparatus as recited in claim 21, wherein the mechanical lifting means includes at least one ballscrew shaft and a nut linked to the upper movable platform and driven by the electrical motor drive means.

23. The apparatus as recited in claim 21, wherein the electrical motor drive means is a single electric motor.
